(19) United States
(12) Patent Application Publication
(10) Pub. No.: US 2018/0263246 A1
(43) Pub. Date: Sep. 20, 2018

(54) HIGHLY CONCENTRATED HIGH-FUNCTIONAL LIME BORDEAUX LIQUID AND METHOD FOR PREPARING SAME

(71) Applicant: Phytoncide Lab Co., Ltd., Yongin-si, Gyeonggi-do (KR)

(72) Inventor: Chul Tae LEE, YONGIN-SI (KR)

(73) Assignee: Phytoncide Lab Co., Ltd., Yongin-si, Gyeonggi-do (KR)

(21) Appl. No.: 15/740,564

(22) PCT Filed: Jun. 29, 2016
(86) PCT No.: PCT/KR2016/006981

§ 371 Date: May 28, 2018

(30) Foreign Application Priority Data
Jul. 1, 2015 (KR) 10-2015-0094192
Jun. 27, 2016 (KR) 10-2016-0080120

(51) Int. Cl. A01N 59/20; A01N 25/02

(52) U.S. Cl. CPC A01N 59/20; A01N 25/02

(57) ABSTRACT

The present invention relates to a highly concentrated transparent “bordeaux liquid” having multi-functionality, and to a preparation of a highly concentrated transparent “bordeaux liquid” having multi-functionality. More specifically, the present invention is directed to a “bordeaux liquid” applicable to various disease and insect damages on the basis of the features thereof, in which: the bordeaux liquid can be stably preserved for a long period of time without causing poor dispersion both at the concentration at the time of concentration and the concentration at the time of use before the spraying of the bordeaux liquid; after the bordeaux liquid is sprayed on leaves or fruit trees, water-insoluble calcium hydroxide and water-insoluble calcium sulfate are attached to the leaves of the fruit trees to inhibit a vigorous respiration action or block sunlight, and as a result, the photosynthetic rate of plants is not decreased; yellow-white precipitates, even when adhering to fruits or chili peppers, do not damage the beauty of the products; and the bordeaux liquid does not permit easy exfoliation or elution by external physical pressure or rainwater even after spray and after drying. The purpose of the present invention is to provide: a highly-concentrated multi-functional “bordeaux liquid”, in which a multi-functional “bordeaux liquid” having the foregoing functionalities is highly concentrated to be convenient in use; and a method for preparing a highly-concentrated multi-functional “bordeaux liquid”. The present invention relates to a method for preparing highly concentrated high-functional lime bordeaux liquid, wherein, when the lime bordeaux liquid is used, there is no problem of a nozzle or the like becoming clogged due to the precipitation of lime as a raw material ingredient; there is no need for agitation at each time of use since the precipitation of raw ingredients does not occur during the long-term storage of the bordeaux liquid; the bordeaux liquid has excellent dispersing stability to maintain a uniform concentration; the bordeaux liquid has excellent deposition stability immediately after spraying and after drying; and the mark of the lime material, which causes a deterioration of product quality immediately after spraying, is not left; and especially, the bordeaux liquid can be concentrated to a high concentration, thereby reducing the packaging container and saving the cost of transport.

### TECHNICAL FIELD

The present invention relates to a method for preparing highly functional highly concentrated lime Bordeaux mixture, which does not result in the problem of clogging of nozzles or the like when the lime Bordeaux mixture that is used as a raw material ingredient precipitates. There is no need to stir because there is no precipitation of raw material ingredients during a long-term storage. The present invention also relates to a method for preparing the highly functional highly concentrated lime Bordeaux mixture which has the excellent dispersion stability while maintaining the uniform concentration, and which is excellent in the electrodeposition stability immediately after the dispersion of the mixture and after drying, and which has no property of leaving a trace of the lime material immediately after the dispersion, which is the cause of the deterioration of the merchantability of products. The present invention relates to a method for producing a highly functional highly concentrated lime Bordeaux mixture, which provides a reduction in the volume of a container and a reduction in the transportation cost.

### INVENTION TECHNOLOGY

After discovering that a mixture of copper sulfate and lime is effective in downy mildew of grapes, it is a “Bordeaux mixture” that has been widely used as a disinfectant or pesticide for many crops such as grapes, fruits, and vegetables. Conventionally, the Bordeaux mixture is produced by using copper sulfates and quicklimes as raw materials in the manufacture of the Bordeaux mixture, but it is not a solution (Bordeaux solution) because the raw lime do not dissolve but rather precipitate. As such, it is correct to say that it is a Bordeaux mixture not a Bordeaux solution.

The conventional methods for manufacturing the Bordeaux mixture can be represented by the following reaction formula.

CaO+H₂O→Ca(OH)₂ \textcircled{1}

CuSO₄+2H₂->H₂SO₄+Cu²+2(OH)⁻ \textcircled{2}

Ca(OH)₂+H₂SO₄+CU²⁺->CaSO₄↓+2H₂O+Cu²⁺ \textcircled{3}

As shown in the reaction formula, the raw lime or calcium oxide (CaO) is added to water and allowed to stand for a long time, which results in a lime suspension in which strong alkaline calcium hydroxide (Ca(OH)₂) having a pH of 11-12 is dissolved by hydration reaction. When copper sulfate (CuSO₄) solution is added to the lime suspension for reaction with the copper sulfate (CuSO₄), the sulfate (H₂SO₄) is first produced and copper iond (Cu²⁺) having a sterilizing effect are freed. The calcium hydroxide (Ca(OH)₂) reacts with the sulfate (H₂SO₄) and results in water-insoluble calcium sulfate (CaSO₄) and water, and unreacted copper ions (Cu2+) remain. The unreacted copper ions (Cu2+) act on the microbial cells that are negatively charged and sterilize microorganisms that cause diseases and serve as an agent for treating plants.

However, the above mentioned conventional Bordeaux mixture have many problems. In the conventional Bordeaux mixture, since only raw lime materials can be used as starting materials when the lime solution is prepared, a large amount of lime powder remain due to almost no dissolution of the lime powder during the reaction with water. Since these components are large in the ‘basic copper sulfate calcium’ ratio, these components are separated and precipitated by different weight differences. Therefore, in order to maintain the dispersion stability of the produced conventional Bordeaux mixture, it is necessary to disperse the mixture as soon as possible after preparing the conventional Bordeaux mixture for use.

As for the dispersion stability, in all cases, the dispersion stability gradually deteriorates from a time immediately after the preparation of the ‘Bordeaux mixture’. For example, when the ‘Bordeaux mixture’ prepared for the next day in a previous evening is used for the next morning, problems frequently occur such that insoluble components are precipitated and the dispersion operation is impossible because of the precipitation. Further, even if the precipitated “Bordeaux mixture” is stirred by force to be used for a dispersion operation, it is impossible to re-disperse because of caking effects, and even if it is re-dispersed, nozzles of dispersion devices get clogged and the mixture cannot be uniformly dispersed on the surfaces of the objects such as leaves or fruits or the like.

Due to the low dispersion stability property of the conventional Bordeaux mixture, it is troublesome to use it immediately after being self-prepared. The quality of the conventional Bordeaux mixture varies depending on the experience of workers and the quality of copper sulfate or lime used, and further the pesticidal effect is not uniform, and even the negative chemical effect due to the concentration of copper ions or lime may occur depending upon the target fruits and/or vegetation. Thus, the most techniques relating to improvements of the conventional Bordeaux mixture have been focused on increasing the dispersion properties.

In addition, when sprayed on fruit plants such as grapes, peaches, or citruses, water-insoluble calcium hydroxide or insoluble calcium sulfate adhere to the leaves of the fruit plants to inhibit vigorous plant respiration and block the sunlight. As a result, the photosynthetic rate of the plants may decrease, and thus adversely affect the ripening of the fruits. In addition, when yellowish white water-soluble calcium compounds or insoluble calcium compounds may adhere to the fruits or red peppers, for example, it impairs and affects aesthetic appearance of the products.

As another problem of the conventional Bordeaux mixture, it is necessary to consider maintaining a stable electrodeposition effect after the dispersion. If the electrodeposition stability is poor even with the excellent dispersion stability of the conventional Bordeaux mixture, depending on a surface condition of the dispersion, the dispersion may result in splashing, because of the insufficient electrodeposition, and as a result, the uniform application of the conventional Bordeaux mixture may not be achieved. Moreover, when the electrodeposition is insufficient, the chemical may easily peel off due to physical or chemical factors such as rainwater or wind, after the dispersion and drying, such that a long-term stable effect of the conventional Bordeaux mixture cannot be expected.

The use of lime for the preparation of the conventional Bordeaux mixture may prevent the long-term storage of the mixture because of its low dispersibility. It further makes it impossible to prepare a very highly concentrated Bordeaux mixture and thus it quires a large number of packaging containers and increases the cost of transportation. Also, unless a very high-quality calcium hydroxide is used, it cannot produce the Bordeaux mixture of high quality, which is a big disadvantage that requires a solution.

In addition to addressing the problems and disadvantages described above, there is still a need for multifunctional Bordeaux mixture which are effective against various pathogens and bacteria. Therefore, some suggested a highly functional environmentally friendly solution in which the Bordeaux mixture is mixed with wood vinegar or antibiotics, which is highly functional, however, that does not satisfy the respective required requirements as a natural substance disinfectant or a pesticidal inhibitor.

The present invention addresses the above noted disadvantages and drawbacks of the conventional Bordeaux mixture, and provides a method for producing a new novel Bordeaux solution which can be highly concentrated and multifunctional.

### DETAILED DESCRIPTION OF THE INVENTION

### Technical Challenge

The present invention relates to the production of a highly concentrated transparent ‘Bordeaux solution’ having versatility and multifunctionality. More specifically, it can be stably stored for a long time without causing defective dispersion in both the concentration and the used concentration before the use of the Bordeaux solution for dispersion. After spraying on leaves or fruit plants of the Bordeaux solution, water-insoluble calcium hydroxide or insoluble calcium sulfate is dissolved in water. It does not deteriorate the photosynthetic rate of the plants as a result of inhibiting the vigorous respiratory action or blocking the sunlight by being attached to the leaves of the plants and does not degrade the beauty of the goods when the yellowish white precipitates adhere to the fruits or peppers. Also, the present invention provides the “Bordeaux solution” which after the dispersion or spraying and drying, does not separate and come off due to rain and physical pressure or environmental factors such as rainwater, and which is multifunctional highly concentrated ‘Bordeaux solution’ and the method of preparing the same.

### Means to Solve Technical Challenge

In order to achieve the above objects, the present invention provides a multi-functional high-concentration ‘Bordeaux solution’ by mixing a lime liquid and a copper sulfate solution, wherein the lime liquid is prepared by complexing lime with a chelating agent, and provides a method for producing the Bordeaux solution.

Specifically, the multifunctional, highly concentrated, Bordeaux solution in accordance with the present invention comprises a complexed lime solution in which the calcium source is complexed with the chelating agent and dissolved in water or another solvent; a copper sulfate solution in which copper sulfate is dissolved in water or another solvent; and the complexed lime solution and the copper sulfate solution.

The another solvent is preferably a solvent containing a phytoncide component.

The complexed lime solution may be desirably prepared by mixing 2.0 to 50.0 parts by weight of the calcium source with respect to 1000 parts by weight of the solvent containing the water or the phytoncide component and 3 to 8 times the amount of the calcium ingredient by the chelating agent.

The chelating agent may be at least one of EDTA, EDTA 2Na, EDTA 4Na, acetic acid, lactic acid, citric acid, horn acid, malic acid, tartaric acid, butyric acid, palmitic acid, tartaric acid, gluconic acid, an aqueous solution of organic acids such as propionic acid, oxalic acid, soda oxalate, glycolic acid, and amino acid, a fermented acid solution, vinegar, and fermented vinegar.

Further, the Bordeaux solution may be concentrated 5 times or more depending on the crop, preferably used as a dilution as 200 to 500 times.

Further, it is preferable that the Bordeaux solution is added with an alkaline component.

Further, the alkaline component may be preferably NaOH or KOH.

Further, the Bordeaux solution may include a lime solution in which the calcium source is dissolved in a solvent containing the phytoncide component; and a copper sulfate solution in which the copper sulfate is dissolved in a solvent containing the phytoncide component.

Also, it is preferable that the solvent containing the phytoncide component may contain at least one of an aqueous solution of phytoncide in water or an organic phytoncide essence in oil form.

Further, it is preferable that the phytoncide essence is release-controlled by micro-encapsulation (Release control).

In addition, the present invention provides a method for producing a multifunctional high-concentration Bordeaux solution. The method includes:

(1) complexing an amount of lime required for concentration for a desired concentration with a chelating agent to dissolve the lime in water or other solvent to form a complexed lime solution without precipitation;

(2) preparing an aqueous solution of copper sulfate by dissolving the amount of copper sulfate necessary for the desired concentration in water or another solvent;

(3) adding the aqueous solution of copper sulfate to the complexed lime solution without precipitation;

(4) In order to produce a novel Bordeaux solution capable of being applied to various pests and bacteria beyond the conventional Bordeaux sterilization efficacy, in step (1) or step (2), water-soluble phytoncide may be used as a solvent instead of water for dissolving the lime or copper sulfate;

The present invention also provides a method for producing a novel multifunctional highly concentrated Bordeaux solution.

### Effects of the Invention

The present invention as described herein can be applied to a case where only the environment-friendly materials for pest management prescribed by the Minister of Agriculture and Forestry are used as fungicide, and various kinds of materials may be included. It is possible to increase a level of immunity of plants and to promote the plant growth while using only environmentally friendly substances which are not toxic, such that it will be greatly effective when used in environment friendly farming in the future.

### BRIEF DESCRIPTION OF DRAWINGS

FIG. 1 is a photograph of a perilla leaf after dispersion of a conventional Bordeaux mixture.

FIG. 2 is a photograph of the perilla leaf after dispersion of a novel Bordeaux solution in accordance with the present invention.

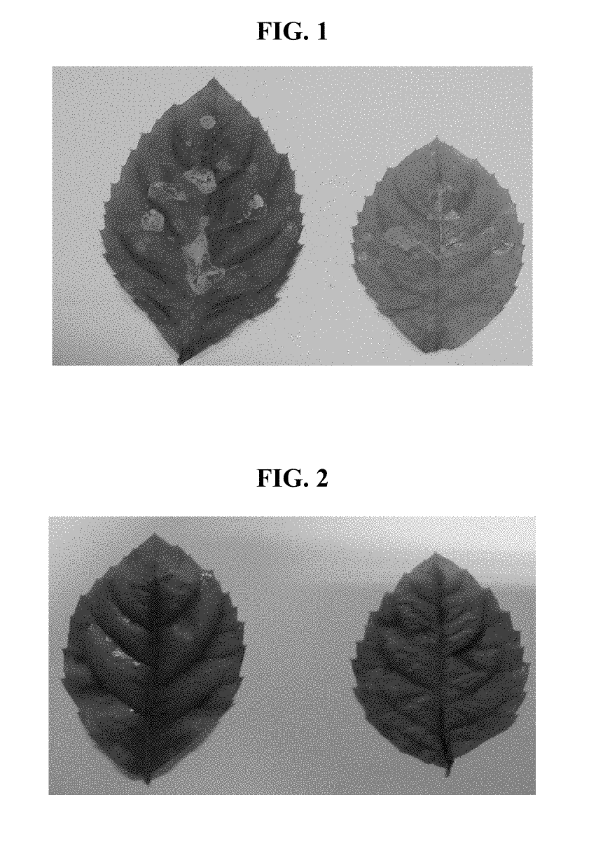

### DETAILED DESCRIPTION OF THE INVENTION

The “Bordeaux mixture” is an environmentally-friendly organic material that has been widely used as a fungicide for many crops including various fruits and vegetables, after it has been found to be effective in downy mildew of grapes. However, the conventional Bordeaux mixture is produced by simply mixing quicklime and copper sulfate, but the lime as the constituent component of the conventional Bordeaux mixture causes a lot of inconvenience and disadvantages such as lowering the stability at the time of using the conventional Bordeaux mixture. That is, since a large amount of lime powder precipitate in the prepared Bordeaux mixture, and ‘basic copper sulfate calcium sulfate’, which is an effective ingredient of the Bordeaux mixture composition, causes dispersion failure in both the concentration and the used concentration before the dispersion, the conventional Bordeaux mixture cannot be stably maintained for a long time. After spraying on leaves or fruit vegetations, they adhere to the leaves of the fruit vegetations and to the surface of fruits to inhibit the vigorous respiration or to block the sunlight. As a result, the photosynthetic rate of the fruits vegetation decreases. In addition, it damages the outward appearance of the products and lowers the value as the commercial products. In addition, the electrodeposition effect deteriorates such that even after drying, it easily peel off due to a physical external pressure or rainwater, as a external environment factor, such that the beneficial effect of the Bordeaux mixture cannot be sustained. Furthermore, the lowered stability of the Bordeaux mixture makes it impossible to make the concentration of the mixture very high, which may result in a decrease in the sales and an increase in the transportation costs as commodities.

In addition, the lowered stability due to the precipitation restricts incorporation of other medicines or ingredients that are effective for other insect or pests control, making it difficult to produce high quality multifunctional Bordeaux mixture having pesticide-eradication and bactericidal or disinfectant properties in addition to the efficacy of the conventional Bordeaux mixture.

Accordingly, the inventor of the present invention has devised a novel Bordeaux solution and a method for manufacturing the novel Bordeaux solution capable of addressing the above mentioned disadvantages and drawbacks of the conventional Bordeaux mixture and having a highly concentrated, highly functional multidrug-resistant bacillus solutions.

Hereinafter, the present invention will be described in detail.

The present invention relates to a method for producing a highly functional ‘Bordeaux solution’ by mixing a complex lime solution and a copper sulfate solution, a method for producing the same. The complex lime solution is prepared by complexing a calcium source with a chelating agent to form a lime solution completely dissolved in a solvent. More particularly, the present invention relates to a very novel lime Bordeaux solution.

Specifically, the highly functional highly concentrated lime Bordeaux solution of the present invention comprises a complex lime solution in which a calcium source is complexed with a chelating agent and dissolved in water or another solvent; a copper sulfate solution in which copper sulfate is dissolved in water or another solvent; and the copper sulfate solution is contained in the complexed lime solution.

The other solvent is preferably a solvent containing a phytoncide component.

Specifically, the method for producing a highly functional highly concentrated lime Bordeaux solution of the present invention comprises:

(1) complexing an amount of calcium source necessary for a desired concentration with a chelating agent to dissolve the calcium source in water or other solvent to form a complexed lime solution that does not have precipitation;

(2) preparing an aqueous copper sulfate solution by dissolving an amount of copper sulfate necessary for a desired concentration in water or another solvent;

(3) a step of adding the aqueous copper sulfate solution to the complexed lime solution without precipitation;

(4) In order to produce a Bordeaux solution capable of being applied to various pests and bacteria beyond the conventional bactericidal effect of Bordeaux mixture, in the step (1) or (2), a solvent containing a phytonchide component may be used as a solvent for dissolving the lime or copper sulfate, rather than water.

The present invention also provides a method for producing such a multifunctional highly concentrated Bordeaux solution.

The present invention also relates to a lime Bordeaux solution including a lime solution in which a calcium source is dissolved in a solvent containing a phytonchide component; and a copper sulfate solution in which copper sulfate is dissolved in a solvent containing phytoncide components.

Recently, a multifunctional Bordeaux solution which is effective against various pathogens and bacteria has been demanded. Therefore, a highly functional environmentally friendly fungicide is proposed by mixing wood vinegar solution or antibiotic with a Bordeaux mixture, but as a natural germicide or pesticide, has not been proposed yet. In the present invention, by using a solvent containing a phytonchide component, a lime Bordeaux solution including various functions that are environmentally friendly is provided.

The solvent containing the phytoncide component may be an aqueous solution of phytoncide in water, an organic phase phytoncide essence in oil form, or a mixture of aqueous phytoncide aqueous solution and phytoncide essence in oil may be mixed and used.

In the case of the complexed lime solution in the highly functional highly concentrated lime Bordeaux solution and the method for producing the same.

Conventionally, in the manufacture of a Bordeaux mixture, calcium component (calcium source) is produced based on calcium oxide (CaO). This quicklime is insoluble in water or most polar solvents and is the root cause of the most of the disadvantages and problems of using the Bordeaux mixture. Therefore, all of these disadvantages and problems can be solved if the calcium component can be present in a liquid ionic phase rather than in a solid phase precipitate. This study is characterized by the fact that a chelating agent is used to solve the problems by chelating the calcium component. The calcium component is ionized by using the chelating agent, and the produced ‘Bordeaux solution’ because no precipitation occurs in the lime solution can ensure a high uniform stability and include a calcium component sufficiently larger than the amount of calcium in the conventional Bordeaux mixture. As such, it is also possible to produce the Bordeaux solution of a very high concentration.

In the manufacture of the highly functional highly concentrated lime Bordeaux solution and the method for producing the same, a complexed lime solution,

an amount of calcium source and an amount of complexing agent necessary for a desired concentration can be adjusted in accordance with an amount of water required to make the lime solution or 1000 parts by weight of other solvent,

the calcium source is mixed in an amount of 2.0 to 50.0 parts by weight, and the complexing agent (chelating agent) is mixed in an amount of 3 to 8 times the weight of the calcium source.

When the amount of the calcium source is 2.0 parts by weight, it is difficult to expect a beneficial effect when the amount of the calcium source is 2.0 parts by weight or less. If the amount of calcium is 50.0 parts by weight or more, the calcium source may not dissolve and remain; this is because the calcium source may be precipitated in an excess amount to dissolve.

The complexing agent does not completely complex the calcium component when the amount of the complexing agent is less than 3 times the amount of the calcium source. The amount of the complexing agent is excessive when the amount of the complexing agent is more than 8 times the amount of calcium source.

More specifically, it is preferable to use quicklime as the calcium source, 2.0 to 50.0 parts by weight of the quicklime, and the complexing agent (chelating agent) 3 to 8 times of the weight of the quicklime. When the amount of quicklime is about 2.0 parts by weight, it is difficult to expect a beneficial effect when the amount of quicklime is 2.0 parts by weight or less, which represents the pharmacological effect of the conventional Bordeaux mixture. When the amount of quicklime is 50.0 parts by weight or more, the calcium source can precipitate without dissolving because of its excessive amount. If the amount of complexing agent is 3 times or less than that of that calcium source, the calcium compound does not completely complex. If the amount of complexing agent is 8 times or more, it is an excessive amount.

Further, in the preparation of the lime Bordeaux solution in accordance with the present invention, there may be a small amount of uncomplexed impurity components depending on a level of the purity of the quicklime or raw lime material, and a small amount of precipitation may occur in a lower part of the Bordeaux solution. However, the precipitation may be filtered and the Bordeaux solution without the precipitation may still be effective since it is the highly concentrated lime Bordeaux solution in the chelated state.

In the above manufacturing or preparing of the complexed lime solution or the highly concentrated lime Bordeaux solution, the calcium source is dissolved in a solvent. In the process, the chelating agent that can be used to dissolve the calcium source may include one of EDTA, EDTA·2Na, EDTA·4Na, acetic acid, lactic acid, citric acid, aqueous solution of organic acids such as succinic acid, malic acid, tartaric acid, butyric acid, palmitic acid, tartaric acid, gluconic acid, sodium gluconate, acetic acid, propionic acid, oxalic acid, soda oxalic acid, glycolic acid and amino acid, fermented acid solution, vinegar and fermentation vinegar, and vinegar.

In order to prepare the novel ‘Bordeaux solution’ applicable to various insect or pests control as pesticides, a phytoncide aqueous solution may be used as a solvent for dissolving the calcium in the step of preparing the above complexed lime solution.

Phytoncide is known to be a very effective natural antiprotozoal or pesticidal agent. However, when phytoncide that is usually produced by extraction and is an organic phase in an oil form, is added to the Bordeaux solution, the stability and uniformity of the Bordeaux solution may be lost, and as such the incorporation of phytoncide into the Bordeaux solution is not easy. Therefore, in an aspect of the present invention, a phytoncide component is extracted by a steam distillation method from coniferous trees such as cypress, cedar, pine and pine trees. The extracted phytoncide component may include an organic phase phytoncide essence of oil having a high volatility and a phytoncide solution that contains a water-soluble phytoncide component. In an aspect of the present invention, the phytoncide solution is used a solvent for dissolving the quicklime.

In addition, in an aspect of the present invention, by adding an organic phase phytoncide essence in the form of oil to the “Bordeaux solution” that is applicable for various insects and/or pests control. In this case, however, the organic phase phytoncide essence oil may be added after emulsion of the organic phase phytoncide essence oil.

Also, since the phytoncide essence is very volatility, a technique for release control is needed so as to prevent volatilization while acting on the insects and/or pests. Here, the phrase ‘release control’ means a technique for slowing letting the material to come out after the entrapment of the material. For this purpose, the phytoncide essence is wrapped around a microcapsule with fine holes so that the phytoncide slowly leaks out.

The solvent containing the phytoncide component may be a mixture of an aqueous solution of a chitosan (or phytoncide solution) and phytoncide essence in microcapsules.

The phytoncide component can be used as a natural pesticide agent because it contains the following ingredients.

(1) Verbenone: Terpene, a kind of pheromone, acts as an anti-inflammatory activity. Trees secrete a substance called ‘terpene’. The terpene that is released from the trees are about 140 types. We often come across some of terpenes, such as oil, resin, carotene. The effects and efficacy of terpenes varies. The most known of these is a function that kills or suppress the growth of bacteria, fungi, parasites, and insects. Because of this function, terpenes are used as pesticides, fungicides, preservatives, skin irritants, anti-inflammatory agents, disinfectants, and fatigue busters. The terpene that is released from the tree is mixed in the air because it is volatile. When terpenes are absorbed into a body of a human, they invigorate the body, help to calm down, and can also perform sterilization and insecticidal action. Terpene can promote the physiological activity of our body when we take a certain amount of terpene.

(2) Alpha-Terpineol: it is reported that alpha-terpineol has effects of a powerful preservative and antiseptic against bacteria, viruses and fungi. It suppresses acne-causing bacteria, fungus and scalp-induced fungus activity, and prevents forming of whiteheads and blackheads from removal of skin fat, has an anti-inflammatory effect, and inhibits the growth of microorganisms.

(3) Camphor: it is an extract having the effects of skin itching relief, stress headache and neuralgia relief, cold, bronchitis, arthritis treatment, strong antifungal effect, and is used as an insecticide.

(4) Fenchol: it produces a fragrance of pine trees.

(5) Borneol: it is used as a soft painkiller, anti-hypertension, pustuler, firming agent, etc.

(6) p, alpha-Dimethylstyrene: it is used as an air freshener and a flavoring agent.

(7) Myrtenol: it produces a fragrance of grass or camphor tree, inhibits the movement of inflammatory mediators, and plays a role in the pathway of receptor signaling pathways involved in the effective treatment of immunoinflammatory diseases and pain transmission.

(8) Carveol: it suppresses strong tonic, tonsil, excited, strong antimicrobial activity.

(9) Carvone: it suppresses cause of breast cancer and eliminates the characteristic smell of fish.

(10) Benzaldehyde: it has an antimicrobial effect like ethanol. It is however more toxic than ethanol, and it is known to have an effect to treat the central nervous system depression and cancer.

(11) d-Fenchone: it is used as synthetic fragrance materials and supplements which are used as flavor additives in foods and beverages.

In the manufacture of the highly functional highly concentrated lime Bordeaux solution, and the method of preparing the complexed lime solution, the conventional Bordeaux mixture always uses quicklime or raw lime as the calcium source, but in an aspect of the present invention, the novel lime Bordeaux solution, calcium hydroxide (Ca(OH)₂) and/or calcium carbonate (CaCO₃) may be used, in addition to the quicklime (CaO).

In the manufacture of the highly functional highly concentrated lime Bordeaux solution and the method of preparing a copper sulfate solution, an amount of copper sulfate necessary for a desired concentration is dissolved in water or another solvent to prepare the copper sulfate solution. The amount of copper sulfate in the ‘Bordeaux solution’ to be produced depends on whether the Bordeaux solution will be a strong Bordeaux solution or a weak Bordeaux solution. In the strong Bordeaux solution, an amount of lime is greater than an amount of copper sulfate, and in the weak Bordeaux solution, the amount of lime is less than the amount of copper sulfate. Basically, the same amount of copper sulfate as the amount of calcium source may be dissolved in the step of producing the complexed lime solution.

Also, in the manufacture of the highly functional highly concentrated lime Bordeaux solution and the method of preparing the copper sulfate solution, to prepare the novel Bordeaux solution which is applicable for various insects and/or pests control, the solvent for dissolving the copper sulfate may include, instead of water, a phytoncide aqueous solution including a phytoncide component, or phytoncide essence in a microcapsule, or a mixture.

In the method of manufacturing the highly concentrated multi-functional Bordeaux solution, in step (3) of manufacture above, a step of slowly heating up the copper sulfate solution of step (2) which is added to the complexed lime solution of step (1) may be included to produce the highly concentrated multi-functional “Bordeaux solution.”

In the method of the manufacture of the highly concentrated multi-functional Bordeaux solution, the copper sulfate of step (2) and the complexed lime solution of step (1) may be mixed by the same weight, but it is not limited thereto, and as needed, a mixing ratio of the two may vary in a selective manner.

In the present invention, the Bordeaux solution means a very highly concentrated solution, which can be concentrated to a concentration of 20 times or more based on a rate of 8-8, but it is preferably concentrated to about 5-10 times for the stability of the prepared Bordeaux solution.

Also, in an aspect of the present invention, when the Bordeaux solution is sprayed or dispersed on a crop, depending upon a type of crop, it can be diluted to 200 to 500 times for use, but it is generally preferable to use a dilution of 500 times.

The highly concentrated multifunctional ‘Bordeaux solution’ prepared according to the present invention can be lowered, due to use of the chelating agent, in pH of the Bordeaux solution from 8 to 9, unlike the conventional Bordeaux mixture having an alkaline pH of 11 to 12. Also, a small amount of an alkali component if necessary may be added because the effectiveness of copper is effectively expressed under basic conditions. The alkaline component is preferably characterized by being capable of adding a small amount of Sodium Hydroxide (NaOH) or Potassium Hydroxide (KOH).

In an aspect of the present invention, in the Bordeaux solution prepared as described herein the lime is completely dissolved and thus any lime powder does not remain in the solution, and the supply of calcium to the crop is excellent, such that various physiological disorders of the crop can be prevented. In addition, although it is highly concentrated, it is applicable to most crops because it has little toxicity of copper sulfate and ill effects. It is also effective against a wide range of pathogens. In addition, the novel Bordeaux solution is easy to use and does not reduce the commercial value of products because it does not leave any opaque residues (limestones) on leaves or fruits, vegetations, crops, etc. Also, during a long-term storage of the novel Bordeaux solution, it can maintain the color, condition and efficacy of the novel Bordeaux solution. It also prevents diseases but also has a considerable treatment effect after an onset of a disease.

In addition, the novel Bordeaux solution of the present invention can be mixed with environmentally friendly organic farming materials (mainly pesticide inhibitors) which could not be mixed and used with the conventional Bordeaux mixture. There is no need to worry about using the novel Bordeaux solution during a flowering time because there is no the lime powder that may be applied to flowers, which results in an advantage of all-time spraying.

Further, the conventional Bordeaux mixture has an harmful or negative effect when it is dispersed after raining or raining after one week of spraying or dispersion, and when at the time of dispersion the external temperature is above 30° C.; that is, it is observed an effect of drying of leaves. In contrast, the novel Bordeaux solution of the present invention does not have an negative effect as long as there is no rain within 24 hours of dispersion or spraying, and the spraying is also possible regardless of the external temperature. In addition, the conventional Bordeaux mixture can cause a respiratory disorder for an operator due to inhalation of fine lime powder into a respiratory tract of the operator, and the lime powder can cause eye damage or visual impairment of the operator. In addition, the lime powder of the conventional Bordeaux mixture may cause skin disease when the lime powder comes in contact with a skin of the operator. In contrast, the novel Bordeaux solution of the present invention is in the form of complete solution without any fine lime powder, and thus it does not create any of the concerns as described above.

The novel Bordeaux solution according to the present invention may be used in such a way that a frequency of dispersion and an amount of the Bordeaux solution may be suitably selected and adjusted for spraying or dispersion on the crops such as plants, and other crops or the like in accordance with the general practices.

Hereinafter, the present invention will be described in more detail by way of examples. These embodiments are for purposes of illustration only and are not intended to limit the scope of protection of the present invention.

### EXAMPLE EMBODIMENTS

The present invention will be described by way of examples and comparative examples.

In the examples, “%” represents weight % unless otherwise specified, and “parts” represents parts by weight.

<Example: Preparation>

Weigh 1 kg of pine nut by-products what were dried in the shade and 2 to 4 cm in size and place them into a 5-liter round flask. Using a separate steam generator to maintain the distillation temperature at 100±3° C., and generate steam to pass through directly a lower part of the sample in the round flask. The steam is distilled for a predetermined time. The solution obtained by steam distillation separates an oil phase and a water phase by weight differences. The separated oil phase is phytoncide oil, and the water phase is a water soluble phytoncide solution containing a water soluble phytoncide component. Each of the obtained phytoncide oil and phytoncide solution was separated, sealed and refrigerated. The component analysis discloses that the oil phase includes phytoncide essence, and the water phase includes a water-soluble phytoncide component having a pesticidal effect, and was then used in the preparation of the novel Bordeaux solution.

### COMPARATIVE EXAMPLES

For the preparation of the Bordeaux mixture, first, two non-metallic containers are prepared. One container includes 4.0 g of copper sulfate was added to 1000 parts by weight of water to prepare 80 to 90% of the desired solution in which the copper sulfate is dissolved in water. In the other container, 4.0 g of quicklime or raw lime is placed, and a small amount of water is added for slaking. Then, the remaining 10 to 20% of water is added to make lime oil. Then stir well the lime oil that has been completely cooled, gradually adding a small amount of the copper sulfate solution, and it becomes the conventional 4-4 type Bordeaux mixture.

### Example 1

In the preparation of the new novel Bordeaux solution according to the present invention, two non-metallic containers are prepared. In one container, 4.0 g of copper sulfate is added to 600 ml of water to obtain a diluted copper sulfate solution. In the other container, 4.0 g of quicklime is added to 400 ml water with 30 ml of EDTA.2Na to prepare transparent lime solution. Then a copper sulfate solution is gradually added by a small amount to the transparent lime solution in which the lime is completely dissolved to obtain the new novel Bordeaux solution.

### Example 2

In the preparation of a new novel ‘Bordeaux solution’ that is applicable to various insects and/or pests control in accordance with the present invention, two non-metallic containers are first prepared. In one container, 4.0 g of copper sulfate is added to 600 ml of the phytoncide aqueous solution as prepared in <Example: Preparation> to prepare a copper sulfate solution. In the other container, 400 ml of a phytoncide solution is added to 4.0 g of quicklime or raw lime and 30 g of EDTA.2Na as prepared in <Example: Preparation> to prepare a complexed solution. The copper sulfate solution is slowly added by a small amount to the transparent phytoncide lime solution which contains phytoncide and in which the lime is completely dissolved, to obtain the new novel Bordeaux solution applicable for various pesticidal effects.

### Example 3

In the preparation of the highly concentrated Bordeaux solution of the present invention, two non-metallic containers are first prepared. In one container, 20.0 g of copper sulfate is added and dissolved in 600 ml of water to obtain a copper sulfate solution. In the other container, 20.0 g of quicklime and 130 g of EDTA.2Na are added to 400 ml of water to obtain a complexed solution. The copper sulfate solution is slowly added by a small amount to the transparent lime solution which contains the lime completely dissolved, to obtain the new novel Bordeaux solution that is 5 time more concentrated than the conventional 4-4 type Bordeaux mixture.

### Example 4

In the preparation of the highly concentrated Bordeaux solution of the present invention, which can be applied to various insects and/or pests in accordance with the present invention, two non-metallic containers are first prepared. In one container, 600 ml of the phytoncide aqueous solution as prepared in <Example: Preparation> is added to 20 g of copper sulfate to obtain a copper sulfate solution. In another container, 400 ml of phytoncide solution as prepared in <Example: Preparation> is added to 20.0 g of quicklime and 130 g of EDTA.2Na to make a complexed solution in which the quicklime is completely dissolved. The copper sulfate solution is slowly added by a small amount to the transparent phytoncide lime solution which contains the phytoncide and the lime completely dissolved, to obtain the new novel Bordeaux solution that is 5 time more concentrated than the conventional 4-4 type Bordeaux mixture. The new novel Bordeaux solution is very highly concentrated and multi-functional and applicable for various pesticidal effects.

### Example 5

In Example 1 above, the procedure is repeated except that calcium hydroxide (Ca(OH)₂) is used instead of the quicklime in Example 1.

### Example 6

In Example 2 above, the same procedure as in Example 2 is carried out except that calcium hydroxide (Ca(OH)₂) is used instead of the quicklime in Example 2.

### Example 7

In Example 3 above, the same procedure as in Example 3 is carried out except that calcium hydroxide (Ca(OH)₂) is used instead of the quicklime in Example 3.

### Example 8

In Example 4 above, the same procedure as in Example 4 is carried out except that calcium hydroxide (Ca(OH)₂) is used instead of the quicklime in Example 4.

### Example 9

In Example 3 above, the same procedure as in Example 3 is repeated except that 10 g of quicklime and 10 g of calcium hydroxide are used in place of 20 g of the quicklime in Example 3.

### Example 10

In Example 4 above, the same procedure as in Example 4 is repeated except that 10 g of quicklime and 10 g of calcium hydroxide are used in place of 20 g of quicklime.

### Example 11

In the preparation of the new novel Bordeaux solution in accordance with the present invention, two non-metallic containers are prepared first. In one container, 4.0 g of copper sulfate is dissolved in 600 ml of water to obtain a diluted copper sulfate solution, and in the other container, 4.0 g of quicklime and 40 g of sodium gluconate are mixed with 400 ml of water to obtain a complexed solution. The copper sulfate solution is slowly added by a small amount to the transparent lime solution which contains the lime completely dissolved, to obtain the new novel Bordeaux solution.

### <Example 12

In the preparation of the new novel Bordeaux solution in accordance with the present invention, two non-metallic containers are prepared first. In one container, 4.0 g of copper sulfate is added to 600 ml of water to make a diluted copper sulfate solution, and in the other container, 4.0 g of quicklime and 45 g of oxalic acid soda are mixed with 400 ml of water to form a complexed solution. The copper sulfate solution is slowly added by a small amount to the transparent lime solution which contains the lime completely dissolved, to obtain the new novel Bordeaux solution.

### Example 13

In the preparation of the new novel Bordeaux solution in accordance with the present invention that has various pesticidal effects two non-metallic pails are first prepared. In the other container, 4.0 g of copper sulfate is added to 600 ml of the phytoncide aqueous solution prepared in <Example: Preparation> to obtain a diluted copper sulfate solution. In the other container, 400 ml of a phytoncide solution prepared in <Example: Preparation> is added to 4.0 g of calcium oxide and 50 g of sodium gluconate to prepare a complexed solution. The copper sulfate solution is slowly added by a small amount to the transparent phytoncide lime solution which contains the phytoncide and the lime completely dissolved, to obtain the new novel Bordeaux solution that has various pesticidal effects.

### Example 14

In the preparation of the new novel Bordeaux solution in accordance with the present invention that has various pesticidal effects two non-metallic pails are first prepared. In one container, 4.0 g of copper sulfate is added to 600 ml of the phytoncide aqueous solution prepared in <Example: Preparation> to obtain a diluted copper sulfate solution. In the other container, a 400 ml phytoncide solution prepared in <Example: Preparation> is added to 4.0 g of calcium oxide and 50 g of sodium oxalate to prepare a complexed solution. The copper sulfate solution is slowly added by a small amount to the transparent phytoncide lime solution which contains the phytoncide and the lime completely dissolved, to obtain the new novel Bordeaux solution that has various pesticidal effects.

1. A highly functional highly concentrated Bordeaux solution comprising:
a complexed lime solution in which a calcium source is complexed with a chelating agent and dissolved in a solvent containing water or phytoncide components; and
a copper sulfate solution in which copper sulfate is dissolved in a solvent containing water or a phytoncide component.

2. The highly functional highly concentrated Bordeaux solution according to claim 1, wherein the complexed lime solution includes a mixture of a solvent having 1000 parts by weight, calcium source having 2.0 to 50.0 parts by weight, and the chelating agent having 3-8 times by weight, the solvent containing the water or phytoncide components.

3. The highly functional highly concentrated Bordeaux solution according to claim 1, wherein the chelating agent is at least one selected from the group consisting of EDTA, EDTA·2Na, EDTA·4Na, acetic acid, lactic acid, citric acid, succinic acid, malic acid, tartaric acid, butyric acid, palmitic acid, tartaric acid, gluconic acid, aqueous solutions of organic acids such as acetic acid, propionic acid, oxalic acid, soda oxalate, glycolic acid and amino acid;
Fermented acid solution, vinegar, and fermented vinegar.

4. The highly functional highly concentrated Bordeaux solution according to claim 1, wherein the Bordeaux solution is capable of being concentrated 5 times or more and can be diluted 200 to 500 times depending on a type of crop.

5. The highly functional highly concentrated Bordeaux solution according to claim 1, wherein the Bordeaux solution is further added with an alkaline component.

6. The highly functional highly concentrated Bordeaux solution according to claim 1, wherein the solvent containing the phytoncide component is at least one of an aqueous solution of phytoncide in water phase or an organic phase phytoncide essence in oil form.

7. The highly functional highly concentrated lime Bordeaux liquid according to claim 1, wherein the calcium source comprises at least one or more of calcium oxide (CaO), calcium hydroxide (Ca(OH)₂) and calcium carbonate (CaCO₃).

8. A highly functional highly concentrated Bordeaux solution comprising:
a lime solution in which a calcium source is dissolved in a solvent containing a phytoncide component; and
a copper sulfate solution in which copper sulfate is dissolved in a solvent containing phytoncide components.

9. The highly functional highly concentrated Bordeaux solution according to claim 8, wherein the solvent containing the phytoncide component is at least one of an aqueous phytoncide solution of an aqueous phase or an organic phase phytoncide essence in the form of an oil.

10. The highly functional highly concentrated Bordeaux solution according to claim 8, wherein the calcium source comprises at least one of calcium oxide (CaO), calcium hydroxide (Ca(OH)₂) and calcium carbonate (CaCO₃).

11. A method for manufacturing a highly functional highly concentrated Bordeaux solution comprising:
a) complexing a calcium source with a chelating agent to prepare a complexed lime solution which is lime dissolved in a solvent containing water or a phytoncide component;
b) preparing a copper sulfate solution in which copper sulfate is dissolved in a solvent containing water or a phytoncide component; and
c) adding the copper sulfate solution to the complexed lime solution while slowly adding thereto.

12. The method according to claim 11, wherein the complexed lime solution is prepared by mixing 2.0 to 50.0 parts by weight of the calcium source with 1000 parts by weight of the solvent containing the water or phytoncide component, and wherein the chelating agent includes 3-8 times by weight of the lime.

13. The method according to claim 11, wherein the calcium source comprises at least one of calcium oxide (CaO), calcium hydroxide (Ca(OH)₂) and calcium carbonate (CaCO₃).

14. The method according to claim 11, wherein the chelating agent is at least one selected from the group consisting of EDTA, EDTA·2Na, EDTA·4Na, acetic acid, lactic acid, citric acid, succinic acid, malic acid, tartaric acid, butyric acid, palmitic acid, tartaric acid, gluconic acid, Aqueous solutions of organic acids such as acetic acid, propionic acid, oxalic acid, soda oxalate, glycolic acid and amino acid; fermenting acid solution, vinegar, and fermentation vinegar.

15. The method according to claim 11, wherein the solvent containing the phytoncide component is at least one of an aqueous solution of phytoncide in water phase or an organic phase phytoncide essence in oil form.

16. The method according to claim 11, wherein the Bordeaux solution is further added with an alkaline component.
